(19) United States
(12) Patent Application Publication
(10) Pub. No.: US 2016/0320950 A1
(43) Pub. Date: Nov. 3, 2016

(54) INFORMATION SEARCH NAVIGATION METHOD AND APPARATUS

(71) Applicant: Alibaba Group Holding Limited, Grand Cayman (KY)

(72) Inventors: Yangyang Kang, Hangzhou (CN); Changlong Sun, Hangzhou (CN); Jun Lang, Hangzhou (CN)

(21) Appl. No.: 15/133,451

(22) Filed: Apr. 20, 2016

(30) Foreign Application Priority Data
Apr. 28, 2015 (CN) 201510206720.8

(51) Int. Cl. G06F 3/0484; G06Q 30/06; G06F 3/0481; H04L 29/08; G06F 17/30

(52) U.S. Cl. CPC G06F 3/04842; H04L 67/22; G06F 17/30643; G06F 17/30696; G06F 3/04812; G06Q 30/0625

(57) ABSTRACT

The present disclosure provides an information search navigation method and apparatus. The disclosed methods and apparatus operate using a process comprises the following steps: monitoring a user operation on a search result page; determining search words corresponding to the search result page when the operation satisfies the preset condition; acquiring and displaying the pre-generated guide information corresponding to the search words, wherein the guide information carries a plurality of keyword tags; and displaying the search result page corresponding to the keyword tags operated by the user. The server can display the guide information corresponding to the search words on the search result page, and also present a more accurate search result page to the user based on the user's keyword tags operation. This improves the efficiency of target information lookup.

### CROSS-REFERENCE TO RELATED APPLICATIONS

This application claims the benefit of priority from Chinese Patent Application No. 201510206720.8, filed on Apr. 28, 2015, entitled “Information Search and Navigation Method and Apparatus Thereof,” which is incorporated herein in its entirety by reference.

### FIELD

The present disclosure relates to the field of computer technology, and more particularly to an information search navigation method and apparatus.

### BACKGROUND

With the developments of information technology, abundant information has become available to users on the Internet. Users can browse this information on the internet via appropriate terminal equipment (such as mobile terminal and/or computer terminal) and utilize this information to enable functionality or operations for accessing various business services (e.g., subscriptions, sharing, and downloads, etc.).

Due to the fact that a variety of information on the internet is provided by internet service providers (e.g., websites), it is difficult to immediately and accurately find the desired target information from a vast information database when the user browses through the information on the websites (e.g., product information). In general, the user often uses keywords for retrieval on relevant websites, but the keywords entered by the user may not always accurately reflect the type of the target information (e.g., product names, models, types and sizes). For this reason, the results retrieved using keywords may contain irrelevant information, and thus the user cannot accurately find the target information.

In the prior art, different index tags are usually generated based on types of information for a massive amount of information stored on the website, from which the user can quickly find the desired information during a retrieval operation.

However, with the above index tag mode, only when the user has a certain understanding of the target information to be found can they more accurately retrieve results offered based on the index tags provided by the website. If the user is not familiar with the target information (e.g., has no knowledge of the performance, range of application and applicability of the product to be found), only the same type of information can be retrieved with the retrieval tag provided by the website. In this case, the user can only browse the information displayed in the retrieval result one by one in order to identify the desired target information. Obviously, the efficiency of this retrieval process is clearly very low.

### BRIEF DESCRIPTION OF THE DISCLOSURE

The embodiments of the present disclosure provide an information search navigation method and apparatus for solving the problem of low-efficiency network information retrieval and query.

An embodiment of the present disclosure provides an information search navigation method, which comprises:

monitoring a user operation on a search result page;

determining search words corresponding to the search result page when the operation satisfies the preset condition;

acquiring and displaying the pre-generated guide information corresponding to the search words, wherein the guide information carries a plurality of keyword tags;

and displaying the search result page corresponding to the keyword tags operated by the user.

An embodiment of the present disclosure further provides an information search navigation device, which comprises:

a monitoring module for monitoring a user operation on the search result page;

a search words determination module for determining search words corresponding to the search result page when the operation satisfies the preset condition;

a guide information module for acquiring and displaying the pre-generated guide information corresponding to the search words, wherein the guide information carries a plurality of keyword tags;

and a display module for displaying the search result page corresponding to the keyword tags operated by the user.

The embodiments of the present disclosure provide an information search navigation method and apparatus. Through the disclosed methods, when the user's operation on the search result page satisfies the preset condition, a corresponding server will determine and display the guide information corresponding to the search words based on such search words entered by the user, so that the user can have some understanding of the desired target information based on the guide information in order to facilitate the subsequent search. In addition, the user can further operate based on the keyword tags carried in this guide information; and then the server will provide the user with a more accurate search result page that corresponds to the keyword tags, thus improving the efficiency of target information lookup. Furthermore, even if the user is not familiar with the target information, the target information retrieval efficiency can still be effectively improved with the aid of such a search mode.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 illustrates the information search navigation process according to some embodiments of the present disclosure;

FIG. 2 illustrates a search result page in according to a non-limiting example in accordance with some embodiments of the present disclosure;

FIGS. 3a-3c illustrate a process in which the server provides the user with information search navigation according to some embodiments of the present disclosure; and

FIG. 4 illustrates a structure of an information search navigation device according to some embodiments of the present disclosure.

### DESCRIPTION OF EMBODIMENTS

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The detailed description provided herein is not intended as an extensive or detailed discussion of known concepts, and as such, details that are known generally to those of ordinary skill in the relevant art may have been omitted or may be handled in summary fashion. Certain embodiments of the present disclosure will now be discussed with reference to the aforementioned figures, wherein like reference numerals refer to like components.

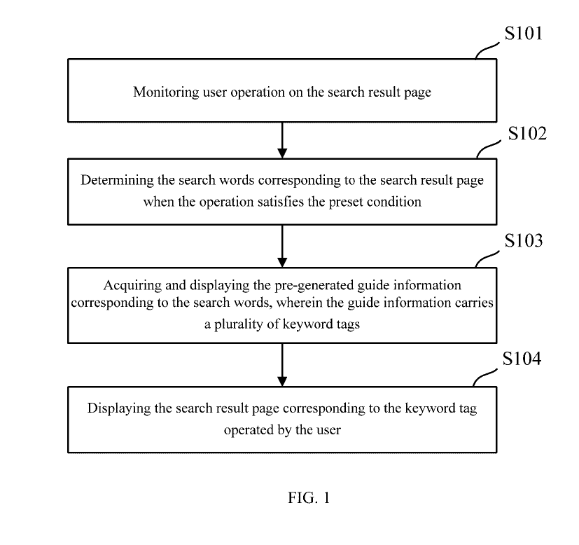

FIG. 1 illustrates an information search navigation process provided in accordance with some of the embodiments of the present disclosure, which comprises the following steps:

S101: monitoring a user operation on a search result page;

In some embodiments of the present disclosure, a user can browse a corresponding search result page after retrieving it with relevant search words on a website (e.g. a shopping website, a movies & TV website and a news website) or an application (“APP” or “App”) via different terminal equipment (e.g. smart phones, tablet computers and/or computer terminals). In other words, the search result page is obtained by searching in the server database of the corresponding website or App based on the search words entered by the user, and the retrieved results are pushed in the form of pages to the user's terminal device in the form of a search results page.

The contents presented on the search result page include, but are not limited to, product information, file information and other types of various network resource information; and the operation includes, but is not limited to, a browse operation and click operation, and the like.

S102: determining search words corresponding to the search result page when the operation satisfies a preset condition.

In practical scenarios, if the contents displayed on the search result page contain the desire target information or the information related to the target information, a user often clicks on the relevant content to browse more detailed information. However, if the user is not familiar with the target information, the scope of search words entered by the user is usually too broad; therefore, the contents displayed on the search result page may contain irrelevant information. In this case, the user needs to browse more on the search result page to find out the desired target information. Thus, if the contents on the search result page browsed by the user exceed a preset number and the user does not browse through the search result page in more detail, it is considered that the user is not finding the target information on the current search result page.

As for the above situation, in order to help the user find the target information more easily, the server needs to navigate the information retrieved by the user. Firstly, the server will determine the search words corresponding to the search result page, so as to help the user with information search navigation later.

In combination with the above contents, the preset condition mentioned in step S102 is specifically as follows: the contents that the user browses on the search result page exceed a certain amount and the user does not click on the information shown on the retrieval page for browsing.

Certainly, the navigation initiation button can also be arranged on the search result page of the website or APP in practical use. When the user browses on the search result page but does not find the desired target information from the retrieval results displayed on the search result page, the user can directly operate on the navigation initiation button on the search result page in order to request the server for retrieval result navigation. Therefore, compared with the above-mentioned preset condition, in another non-limiting embodiment, the user can send a navigation request on the corresponding search result page.

S103: acquiring and displaying the pre-generated guide information corresponding to the search words, wherein the guide information carries a plurality of keyword tags.

After determining the search words, the server can then obtain the pre-generated guide information corresponding to the search words and present this guide information to the user. The server can display this guide information in many ways; for example, displaying on the search result page that the user is currently viewing. Another example is that the server can push the new display page to the user terminal so as to display this guide information. The ways to display the guide information, as discussed above, do not impose any limitation on the present disclosure.

According to the prior art, if the user is not familiar with the target information, the user cannot query based on the performance, range of application and applicability of the target information with the retrieval tag provided on the search result page. Therefore, to overcome this shortcoming, in some embodiments of the present disclosure, the server pre-generates various kinds of information stored therein as guide information.

The guide information comprises suggestion tips comprising various information, such as, but not limited to, performance, applicability and range of application. For example, the guide information of a product can contain a detailed description of the product, the applicability of different models of the product and different application scenarios. Thus, the user can obtain the information related to the entered search words with this guide information, by which the user can gain some knowledge of the target information to be found so as to make it easy for the user to find the target information.

In addition, in order to facilitate further search based on the contents in the guide information, the guide information comprises a plurality of keyword tags in the embodiments of the present disclosure.

Unlike the prior art, the keyword tags as mentioned in the embodiments of the present disclosure are not the retrieval tags provided by the traditional search result page, but rather are the navigation tags generated that correspond to the contents in the guide information. As compared to the traditional retrieval tags, the keyword tags provide a more accurate retrieval range.

For example, the guide information of a product comprises the scope of different models of the product; then the navigation tags generated corresponding to the guide information can be the scope information for this product's different models.

S104: displaying the search result page corresponding to the keyword tags operated by the user.

In the embodiments of the present disclosure, the keyword tags carried in the guide information can be treated as more detailed retrieval criteria; therefore, when the user clicks on the keyword tags in the guide information, the server will provide the search result page corresponding to the keyword tags and display such information to the user.

In accordance with the above steps, when the user's operation on the search result page satisfies a preset condition, the corresponding server will determine and display the guide information corresponding to the search words based on such search words entered by the user; the user can then have some understanding of the desired target information based on the guide information to facilitate his subsequent search. In addition, the user can select the keyword tags carried in the guide information, and the server will display a more accurate search result page that corresponds to the keyword tags to the user, thus improving the efficiency of target information lookup. Furthermore, even if the user is not familiar with the target information, the target information retrieval efficiency can still be effectively improved with the aid of such a search mode.

The following are detailed descriptions are based on non-limiting scenarios where the search result page comprises product information, and the guide information comprises suggestion tips for the product information. It should be understood that such scenarios are non-limiting in that the disclosed method and apparatus should not be construed to be limited to such embodiment as one of skill in the art would understand that like embodiments, as discussed herein, are applicable to the present disclosure.

When a user applies product information as search words for retrieval of a search result page at a corresponding product website, the server will retrieve all product information stored in the database of this product website based on the search words entered by the user, and display the product information corresponding to the search words on the search result page, so that the user can operate on this search result page.

For the product website server, the user may retrieve any product information that is available in practical use. In order to ensure that the user receives an information search navigation service from the server when the user queries any product information, the server will pre-generate guide information for all the stored product information. The pre-generation of guide information in step S103 is specifically as follows: obtaining the suggestion tips corresponding to the product information in advance; determining the keyword tags based on the suggestion tips; and taking the suggestion tips and the determined keyword tags as the guide information that corresponds to the product information.

The suggestion tips usually include any related product information such as the range of application, applicability and other related descriptive information (e.g. a user guide and/or operating instructions of a product) of the product information. Certainly, the suggestion tips are not limited to text information in the embodiments of the present disclosure. In some scenarios, the suggestion tips can also be picture information, video information, audio information and other information in multimedia forms. When the server tries to obtain the suggestion tips corresponding to the product information, the server can use the product information as a search entry in the specified database or on the internet. If any of the relevant text, image, video, audio and other multimedia information is retrieved, such multimedia information will be used as the suggestion tips of the product information.

Furthermore, the server can generate corresponding keyword tags according to the suggestion tips that correspond to different product information, and the user can search for the keyword tags directly, thus effectively narrowing the search scope.

It should be noted that the reason for the server to be able to generate corresponding keyword tags based on the suggestion tips is that: the suggestion tips comprise the characteristic information (e.g. featured words that reflect the product types, status and service conditions) associated with different product information; then the server generates the keyword tags of this suggestion tips based on such product information and the associated characteristic information.

In some embodiments, the step of determining the keyword tags based on the suggestion tips is as follows: conducting text segmentation for the suggestion tips; carrying out dependency analysis for the contents of each paragraph obtained after text segmentation to determine the product information included in each paragraph and the characteristic information corresponding to the product information, and determining the different combinations of the characteristic information and product information as keyword tags of different paragraphs.

When the suggestion tips are text information, the suggestion tips may contain descriptions with respect to different aspects of the product information. In order to more accurately determine the keyword tags, the server will segment the suggestion tips, to divide the descriptions, with regard to different aspects of the product information, into different paragraphs.

Each different paragraph obtained after segmentation has different corresponding characteristic information making it possible to determine the product information included in a paragraph and the characteristic information corresponding to this product information.

In the embodiments of the present disclosure, a dependency analysis algorithm is applied to determine the product information included in each paragraph, and the characteristic information having dependency relation with this product information. For example, the product information determined from the suggestion tips is “wind coat”, and the characteristic information determined based on a dependency analysis is “slim fit” and “X-style, warm and windproof”.

Generally, the combination of different characteristic information and product information corresponds to different types of commodities; thus in the embodiments of the present disclosure, the server can combine the product information and characteristic information determined from the paragraph and take the combined product information and characteristic information as the keyword tags for different paragraphs.

In addition, the server can combine the determined two characteristic information “slim fit” and “X-style, warm and windproof” as well as the product information “wind coat” in the above example; thus obtaining “slim fit wind coat” and “X-style, warm and windproof wind coat”. Obviously, these two combinations correspond to different types of coats, and the server will use such two combinations as the keyword tags in this paragraph.

However, a plurality of characteristic information may be determined from one paragraph in practical use, i.e., obtaining the combination of a plurality of characteristic information and product information. Some combinations may correspond only too few retrieval results, and others are even invalid search criteria. If such a combination is applied as keyword tags, the user's search navigation will be affected. Therefore, as a preferred mode in the embodiments of the present disclosure, the server screens the generated combinations after combining the product information and characteristic information. The screening mode can be specifically as follows: a server sets appropriate thresholds according to the previously obtained hits, number of visits and other statistical information of different commodities at the website; and it excludes the combinations with hits or number of visits not exceeding the thresholds, but only keeps the combinations with hits or number of visits exceeding the thresholds. This screening process can effectively exclude the combinations that provide ineffective search results; and this does not impose any limitation on the present disclosure.

Considering that the search words entered by the user may differ from the product information stored in the server in practical use, which means the search words entered by the user do not perfectly match with the product information, the server usually is set up with a corresponding fault-tolerant mechanism (e.g. which performs approximate string matching); therefore, the search words entered by the user may still be used for retrieval and the corresponding retrieval results will be generated. For example, if the search words entered by the user are “ [symbol] (mechanical health board)”, in which the character “ [symbol] (key)” is mistyped as “ [symbol] (health)”, the server will retrieve based on the correct words “ [symbol] (mechanical keyboard)”.

In the above circumstance, the wrong search words entered by the user do not have corresponding guide information in the server. To ensure that a normal information search navigation service can still be provided to the user, the pre-generated guide information corresponding to the search words is displayed on the search result page in the embodiments of the present disclosure, which is specifically as follows: determining the search words on the search result page and the product information corresponding to such search words; taking the guide information corresponding to the product information as guide information of the search words, and displaying this guide information. That is to say, even if the search words entered by the user differ from the corresponding product information, when the user browses on the search result page, the server, based on the built-in fault-tolerant mechanism, can determine the product information corresponding to the incorrect search words entered by the user, and take the pre-generated guide information for the product information as the search words. In this way, in spite of the incorrect search words, the user can still browse through corresponding guide information on the search result page. In the present embodiments of the present disclosure, the search result page corresponding to the keyword tags operated by the user is displayed with detailed steps as follows: determining the keyword tags operated by the user; taking the combinations of characteristic information and product information in the keyword tags as search words for retrieval; and displaying the retrieved search result page as the search result page corresponding to the keyword tags.

The combinations of product information and characteristic information included in keyword tags may be taken as relatively accurate search criteria. When the user clicks on the keyword tags, the server will start to search with the combinations of the product information and characteristic information included in the keyword tags as search criteria, and obtain a corresponding search result page. Later, the server will display this search result page to the user to realize the search navigation process of product information.

In another scenario of an embodiment of the present disclosure, the keyword tags comprise the Uniform Resource Locator (URL) for the search result page, which is obtained after searching with the combinations of the product information and characteristic information as search criteria. In this way, the user can directly visit the URL stored in the keyword tags after clicking on the keyword tags in order to visit the corresponding search result page.

A non-limiting, specific practical application example is given as follows to specify the process of information search navigation:

Assuming that a user visits an e-commerce website via the browser on the phone to find a mechanical keyboard with lower noise on key-press.

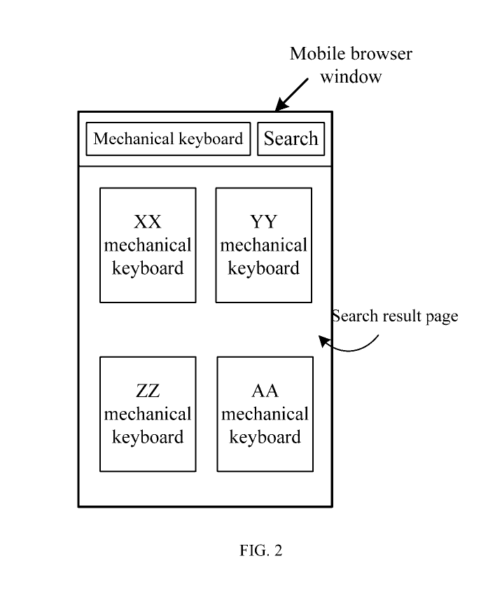

As shown in FIG. 2, the user searches on the e-commerce website by entering search words “mechanical keyboard”, and browses on the corresponding search result page. Assuming that the user has already viewed part of the content on the search result page as shown in FIG. 2, and the user does not find the ideal mechanical keyboard for the reason that only the mechanical keyboard of different brands (“XX”, “YY”, “ZZ” and “AA” in FIG. 2 represent the brands) are displayed on the search result page as illustrated in FIG. 2.

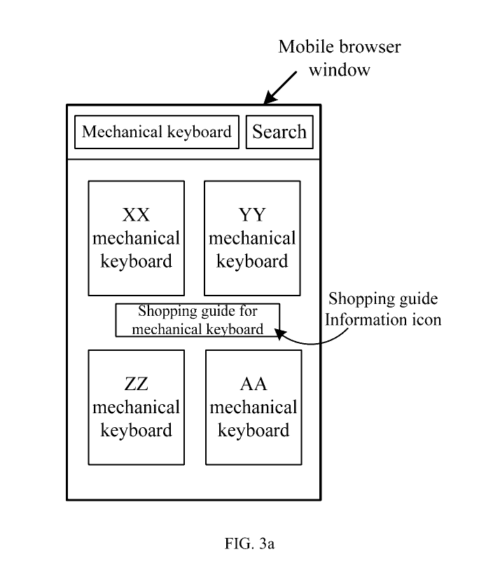

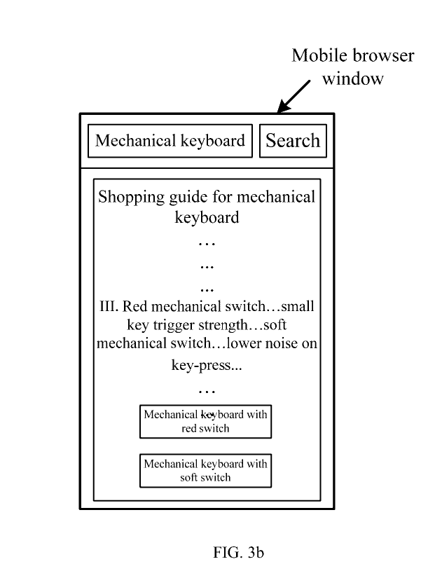

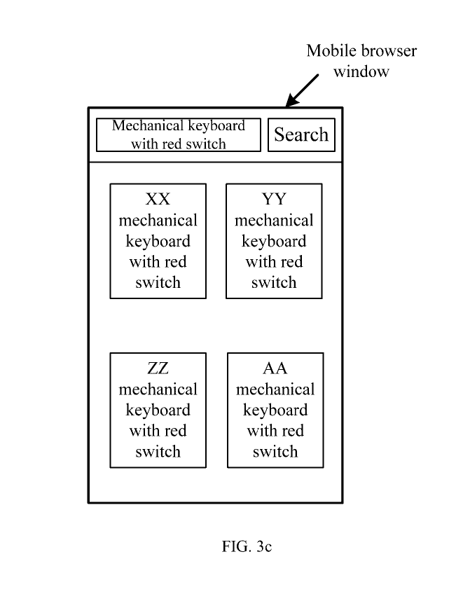

Under this circumstance, the server detects that the user has viewed part of the contents on the search result page without clicking on any of the retrieval result; then, it can be assumed that the user does not find the desired product on the current search result page. For this reason, the server will provide a navigation operation/function for the user on the search result page, and generate a corresponding navigation button as shown in FIG. 3a. In FIG. 3a, a navigation button is displayed on the current search result page in the form of an icon (i.e., the icon “Shopping Guide for Mechanical Keyboard” in FIG. 3a). Certainly, the form of the navigation button in this example is not limited to icons. In practice, a navigation button can be displayed at the sidebar of the page or in the form of a floating window, which does not impose any limitation on the present disclosure.

When the user clicks on this icon, the server will, based on the search words “mechanical keyboard” entered by the user, push the pre-generated guide information corresponding to the search words “mechanical keyboard” onto the current search result page as shown in FIG. 3b.

As shown in FIG. 3b, the guide information of the search words “mechanical keyboard” is displayed on the current search result page via a floating window, wherein the guide information includes the suggestion tips in the form of words and the pre-generated keyword tags based on the suggestion tips. Assuming that one of the paragraphs (obtained after the server conducts text segmentation in advance) in the suggestion tips indicates the type of mechanical keyboards with lower noise on key-press.

For the suggestion tips in FIG. 3b, the server will conduct a dependency analysis on this paragraph in advance, and determine the product information in this paragraph as “mechanical keyboard”, wherein the featured words include “lower noise on key-press”, “red mechanical axis” and “soft mechanical axis”. The server will generate the combinations of product information and different featured words and screen these combinations to finally determine the keyword tags corresponding to this paragraph, i.e., “mechanical keyboard with a red axis” (or a mechanical red axis) and “mechanical keyboard with a soft axis”, as shown in FIG. 3b.

Suppose that the user clicks on the keyword tag of “mechanical keyboard with a red axis”, the server will start a new search with the new search criteria “mechanical keyboard with a red axis” according to the keyword tag clicked by the user, and display the new search result page to the user, as illustrated in FIG. 3c.

In this way, the user can obtain some knowledge of the retrieved mechanical keyboards based on the suggestion tips, and conduct a search navigation according to keyword tags. The search results will then match the desired mechanical keyboard type in a more accurate way.

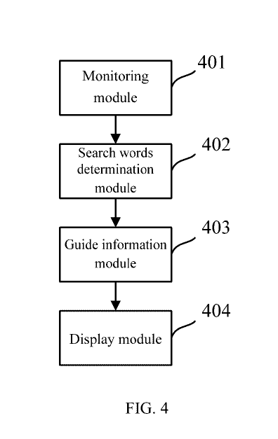

The above is a non-limiting example of the information search navigation provided in the embodiments of the present disclosure. Similarly, the embodiments of the present disclosure further provide an information search navigation device as shown in FIG. 4.

In FIG. 4, the information search navigation device comprises: a monitoring module 401, a search words determination module 402, a guide information module 403 and a display module 404, wherein,

the monitoring module 401 is for monitoring a user operation on the search result page;

the search words determination module 402 is for determining the search words corresponding to the search result page when the operation satisfies the preset condition;

the guide information module 403 is for acquiring and displaying the pre-generated guide information corresponding to the search words, wherein the guide information carries a plurality of keyword tags;

and the display module 404 is for displaying the search result page corresponding to the keyword tags operated by the user.

Under the circumstance that the search result page comprises product information and the guide information comprises suggestion tips for the product information, the guide information module 403 is specifically used for pre-acquiring the suggestion tips that correspond to the product information; determining the suggestion tips based on the keyword tags; and taking the suggestion tips and the determined keyword tags as guide information corresponding to the product information.

The guide information module 403 is used for conducting text segmentation for the suggestion tips; carrying out dependency analyses for the contents of each paragraph obtained after text segmentation, to determine the product information included in each paragraph and the characteristic information corresponding to the product information; and determining the different combinations of the characteristic information and product information as keyword tags of different paragraphs.

The display module 404 is specifically used for determining the search words on the search result page; determining the product information corresponding to the search words; acquiring the guide information corresponding to the product information as the guide information of the search words; and displaying this guide information.

In addition, the display module 404 is used for determining the keyword tags operated by the user; taking the combination of characteristic information and product information in the keyword tags as search words for retrieval; and displaying the search result page obtained after retrieval as the search result page corresponding to the keyword tags.

In a typical configuration, a computing device comprises one or more CPUs, I/O interface, network interface and memory.

The memory may comprise volatile memory, random access memory (RAM) and/or NVRAM and other forms (such as read-only memory (ROM) or flash RAM) with regard to computer readable media. The memory is an example of a computer readable medium.

The computer readable media include volatile, non-volatile, movable and non-movable media, which can realize information storage by any method or technology. The information could be a computer readable instruction, a data structure, a program module or other data. The examples of computer storage media include, but are not limited to, phase-change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disk read only memory (CD-ROM), digital versatile disc (DVD) or other optical memories, cassette magnetic tapes, tapes, disk memory or other magnetic memory devices or any other non-transmission media as well as information stored and accessible by the computing device. According to the definitions herein, the computer readable medium excludes transitory media, such as modulated data signals and carrier waves.

It should be noted that the terms “comprising”, “including” or any other variations thereof are intended to cover a non-exclusive inclusion such that the process, method, article or device comprising a series of elements include not only those elements, but also other elements not expressly listed or the inherent elements of such process, method, product or device. In the absence of more restrictions, the elements defined by the sentence “comprise a . . . ” does not exclude the presence of other identical elements for the process, method, article or device comprising the elements.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

A person skilled in the art shall understand that the embodiments of the present disclosure provide a method, system or computer program product. Accordingly, the present disclosure can be applied with the form of an entire hardware embodiment, an entire software embodiment or a combination of software and hardware embodiments. In addition, the present disclosure can employ the form of a computer program product that can be implemented on one or more available computer storage media (including but not limited to disk storage devices, CD-ROMs and optical memory) comprising available computer program codes.

The above are only embodiments of the present disclosure, and are not intended to limit the scope of the present disclosure. To a person skilled in the art, the present disclosure may take on various alterations and changes. All alterations, equivalent replacements and improvements, etc., without departing from the spirit and principle of the present disclosure, shall fall within the scope of claims of the present disclosure.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure

1. An information search navigation method comprising:
communicating, via a computing device over a network, a search result page to a user;
monitoring, via the computing device over the network, an operation by the user on the communicated search result page, said monitoring comprising analyzing said user operation in accordance with a preset condition associated with said search result page;
determining, via the computing device, search words corresponding to the search result page upon the user operation satisfying a preset condition;
acquiring, via the computing device, pre-generated guide information corresponding to the search words, wherein the guide information carries a plurality of keyword tags;
communicating, via the computing device, said pre-generated guide information to said user for display on a device of said user;
receiving, at the computing device, a selection by said user of at least one of said plurality of keyword tags;
determining, via the computing device, an updated search result page corresponding to the selected keyword tags; and
communicating, via the computing device, said updated search result page to said user for display on said device.

2. The information search navigation method of claim 1, wherein the search result page comprises product information; and the guide information comprises suggestion tips for the product information.

3. The information search navigation method of claim 2, further comprising generating the pre-generation of guide information, said generation comprising:
acquiring suggestion tips corresponding to each product information in advance;
determining keyword tags based on the suggestion tips; and
using the suggestion tips and the determined keyword tags as the guide information corresponding to each product information.

4. The information search navigation method of claim 3, wherein the step of determining keyword tags based on the suggestion tips comprises:
conducting text segmentation for the suggestion tips;
performing dependency analyses for the contents of each paragraph obtained after text segmentation to determine product information included in each paragraph and characteristic information corresponding to the product information; and
determining different combinations of the characteristic information and product information as keyword tags of different paragraphs.

5. The information search navigation method of claim 2, wherein said acquiring further comprises:
determining search words corresponding to the search result page;
determining product information corresponding to the search words;
acquiring guide information corresponding to the product information as the guide information of the search words; and
communicating said guide information to said user.

6. The information search navigation method of claim 4, wherein said communication of said updated search result page comprises:
identifying the keyword tag selected by the user;
combining characteristic information and product information in this keyword tag as keywords for searching; and
using the search result page obtained after searching as the search result page corresponding to this keyword tag for communication to the user, wherein said search result page obtained after searching is said updated search result page.

7. A non-transitory computer-readable storage medium tangibly encoded with computer-executable instructions, that when executed by a processor, perform a method comprising:
communicating, over a network, a search result page to a user;
monitoring, over the network, an operation by the user on the communicated search result page, said monitoring comprising analyzing said user operation in accordance with a preset condition associated with said search result page;
determining search words corresponding to the search result page upon the user operation satisfying a preset condition;
acquiring pre-generated guide information corresponding to the search words, wherein the guide information carries a plurality of keyword tags;
communicating said pre-generated guide information to said user for display on a device of said user;
receiving a selection by said user of at least one of said plurality of keyword tags;
determining an updated search result page corresponding to the selected keyword tags; and
communicating said updated search result page to said user for display on said device.

8. The non-transitory computer-readable storage medium of claim 7, wherein the search result page comprises product information; and the guide information comprises suggestion tips for the product information.

9. The non-transitory computer-readable storage medium of claim 8, further comprising generating the pre-generation of guide information, said generation comprising:
acquiring suggestion tips corresponding to each product information in advance;
determining keyword tags based on the suggestion tips; and
using the suggestion tips and the determined keyword tags as the guide information corresponding to each product information.

10. The non-transitory computer-readable storage medium of claim 9, wherein the step of determining keyword tags based on the suggestion tips comprises:
conducting text segmentation for the suggestion tips;
performing dependency analyses for the contents of each paragraph obtained after text segmentation to determine product information included in each paragraph and characteristic information corresponding to the product information; and
determining different combinations of the characteristic information and product information as keyword tags of different paragraphs.

11. The non-transitory computer-readable storage medium of claim 8, wherein said acquiring further comprises:
determining search words corresponding to the search result page;
determining product information corresponding to the search words;
acquiring guide information corresponding to the product information as the guide information of the search words; and
communicating said guide information to said user.

12. The non-transitory computer-readable storage medium of claim 10, wherein said communication of said updated search result page comprises:
identifying the keyword tag selected by the user;
combining characteristic information and product information in this keyword tag as keywords for searching; and
using the search result page obtained after searching as the search result page corresponding to this keyword tag for communication to the user, wherein said search result page obtained after searching is said updated search result page.

13. An apparatus comprising:
a processor;
a non-transitory computer-readable storage medium for tangibly storing thereon program logic for execution by the processor, the program logic comprising:
logic executed by the processor for communicating, over a network, a search result page to a user;
logic executed by the processor for monitoring, over the network, an operation by the user on the communicated search result page, said monitoring comprising analyzing said user operation in accordance with a preset condition associated with said search result page;
logic executed by the processor for determining search words corresponding to the search result page upon the user operation satisfying a preset condition;
logic executed by the processor for acquiring pre-generated guide information corresponding to the search words, wherein the guide information carries a plurality of keyword tags;
logic executed by the processor for communicating said pre-generated guide information to said user for display on a device of said user;
logic executed by the processor for receiving a selection by said user of at least one of said plurality of keyword tags;
logic executed by the processor for determining an updated search result page corresponding to the selected keyword tags; and
logic executed by the processor for communicating said updated search result page to said user for display on said device.

14. The apparatus of claim 13, wherein the search result page comprises product information; and the guide information comprises suggestion tips for the product information.

15. The apparatus of claim 14, further comprising generating the pre-generation of guide information, said generation comprising:
logic executed by the processor for acquiring suggestion tips corresponding to each product information in advance;
logic executed by the processor for determining keyword tags based on the suggestion tips; and
logic executed by the processor for using the suggestion tips and the determined keyword tags as the guide information corresponding to each product information.

16. The apparatus of claim 15, wherein the step of determining keyword tags based on the suggestion tips comprises:
logic executed by the processor for conducting text segmentation for the suggestion tips;
logic executed by the processor for performing dependency analyses for the contents of each paragraph obtained after text segmentation to determine product information included in each paragraph and characteristic information corresponding to the product information; and
logic executed by the processor for determining different combinations of the characteristic information and product information as keyword tags of different paragraphs.

17. The apparatus of claim 14, wherein said acquiring further comprises:
logic executed by the processor for determining search words corresponding to the search result page;
logic executed by the processor for determining product information corresponding to the search words;
logic executed by the processor for acquiring guide information corresponding to the product information as the guide information of the search words; and
logic executed by the processor for communicating said guide information to said user.

18. The apparatus of claim 16, wherein said communication of said updated search result page comprises:
logic executed by the processor for identifying the keyword tag selected by the user;
logic executed by the processor for combining characteristic information and product information in this keyword tag as keywords for searching; and
logic executed by the processor for using the search result page obtained after searching as the search result page corresponding to this keyword tag for communication to the user, wherein said search result page obtained after searching is said updated search result page.
